(19) United States
(12) Patent Application Publication
(10) Pub. No.: US 2016/0020696 A1
(43) Pub. Date: Jan. 21, 2016

(54) POWER SYSTEM AND CONTROL DEVICE

(71) Applicant: KABUSHIKI KAISHA TOSHIBA, Tokyo (JP)

(72) Inventors: Akihiro Shibata, Tokyo (JP); Tatsunori Kanai, Yokohama (JP); Tetsuro Kimura, Tokyo (JP); Koichi Fujisaki, Kawasaki (JP); Junichi Segawa, Kawasaki (JP); Masaya Tarui, Yokohama (JP); Satoshi Shirai, Kawasaki (JP); Yusuke Shirota, Yokohama (JP); Shiyo Yoshimura, Kawasaki (JP)

(21) Appl. No.: 14/708,462

(22) Filed: May 11, 2015

(30) Foreign Application Priority Data
Jul. 18, 2014 (JP) 2014-148135

(51) Int. Cl. H02M 3/158

(52) U.S. Cl. CPC H02M 3/158

(57) ABSTRACT

According to a power system includes a linear regulator, a step-down switching regulator, and a controller. The linear regulator supplies electrical power to a load. The step-down switching regulator supplies electrical power to the load. Based on input voltage of the linear regulator and the step-down switching regulator and based on load current representing electrical current flowing to the load, the controller performs control to supply electrical power to the load from one of the linear regulator and the switching regulator.

### CROSS-REFERENCE TO RELATED APPLICATIONS

This application is based upon and claims the benefit of priority from Japanese Patent Application No. 2014-148135, filed on Jul. 18, 2014; the entire contents of which are incorporated herein by reference.

### FIELD

Embodiments described herein relate generally to a power system and a control device.

### BACKGROUND

Typically, a power system is known in which, according to an electrical current (a load current) flowing to a device, control for supplying electrical power to the device is performed using either a linear regulator or a switching regulator.

However, in a configuration in which either the switching regulator or the linear regulator is selected using only the magnitude of the electrical current; there are times when the efficiency undergoes a decline, and appropriate reduction in electrical power may not be achieved.

### BRIEF DESCRIPTION OF THE DRAWINGS

FIG. 1 is a diagram illustrating an exemplary configuration of a power system according to an embodiment;

FIG. 2 is a diagram illustrating an exemplary configuration of a voltage measurer according to the embodiment;

FIG. 3 is a diagram illustrating an exemplary configuration of the voltage measurer according to a modification example;

FIG. 4 is a diagram illustrating an exemplary configuration of the voltage measurer according to a modification example;

FIG. 5 is a diagram illustrating an exemplary configuration of a load current measurer according to the embodiment;

FIG. 6 is a diagram illustrating an exemplary configuration of the load current measurer according to a modification example

FIG. 7 is a diagram illustrating an exemplary configuration of the load current measurer according to a modification example

FIG. 8 is a diagram illustrating an exemplary configuration of the load current measurer according to a modification example

FIG. 9 is a diagram illustrating an exemplary configuration of the load current measurer according to a modification example

FIG. 10 is a diagram illustrating an exemplary functional configuration of a controller according to the embodiment;

FIG. 11 is a diagram illustrating an exemplary configuration of an efficiency determiner according to the embodiment;

FIG. 12 is a diagram illustrating an exemplary configuration of an efficiency calculator according to the embodiment;

FIG. 13 is a diagram illustrating an example of correspondence information according to the embodiment;

FIG. 14 is a diagram illustrating an exemplary configuration of the controller according to a modification example;

FIG. 15 is a diagram illustrating an exemplary configuration of the controller according to a modification example;

FIG. 16 is a diagram illustrating an exemplary configuration of the controller according to a modification example;

FIG. 17 is a diagram illustrating an exemplary configuration of the controller according to a modification example;

FIG. 18 is a diagram illustrating an exemplary configuration of the controller according to a modification example;

FIG. 19 is a flowchart for explaining an example of operations performed by the controller according to the embodiment;

FIG. 20 is a diagram illustrating an exemplary configuration of the power system according to a modification example;

FIG. 21 is a diagram illustrating an exemplary configuration of the power system according to a modification example;

FIG. 22 is a diagram illustrating an exemplary configuration of the power system according to a modification example; and

FIG. 23 is a diagram illustrating an exemplary configuration of the power system according to a modification example.

### DETAILED DESCRIPTION

According to a power system includes a linear regulator, a step-down switching regulator, and a controller. The linear regulator supplies electrical power to a load. The step-down switching regulator supplies electrical power to the load. Based on input voltage of the linear regulator and the step-down switching regulator and based on load current representing electrical current flowing to the load, the controller performs control to supply electrical power to the load from one of the linear regulator and the switching regulator.

An embodiment will be described below in detail with reference to the accompanying drawings.

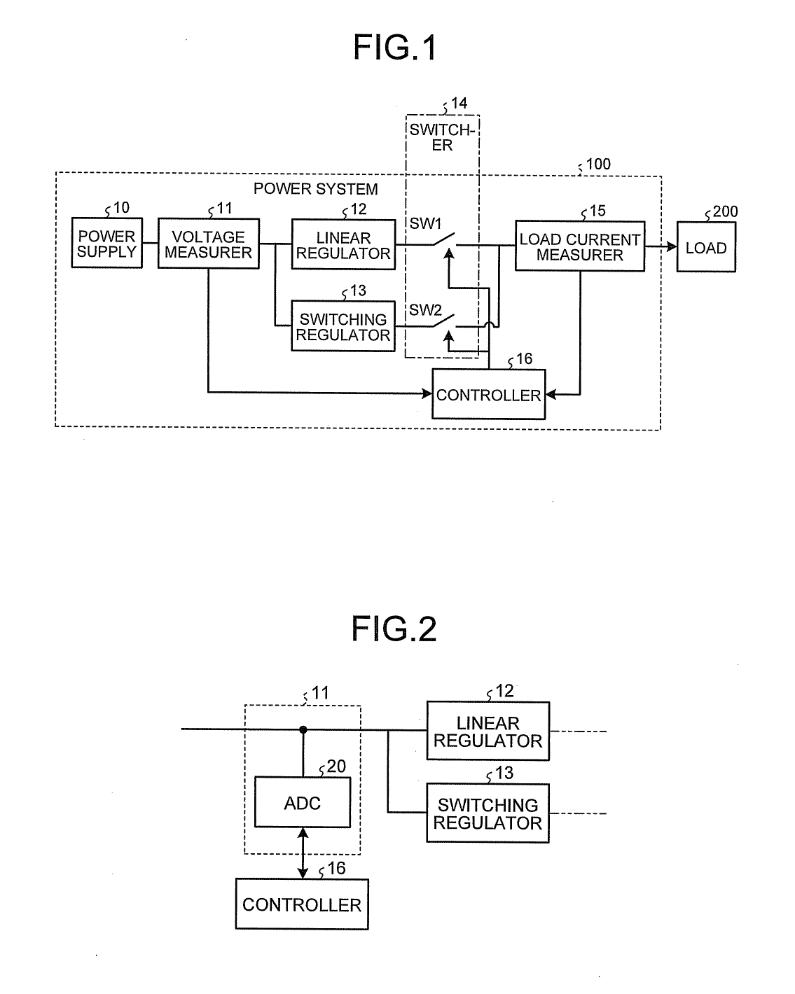

FIG. 1 is a diagram illustrating an exemplary configuration of a power system 100 that supplies electrical power to a load (a load circuit) 200. As illustrated in FIG. 1, the power system 100 includes a power supply 10, a voltage measurer 11, a linear regulator 12, a switching regulator 13, a switcher 14, a load current measurer 15, and a controller 16.

The power supply 10 is a source for supplying electrical power and can be, for example, a photovoltaic cell (a solar panel). However, that is not the only possible case. Herein, the power supply 10 is assumed to have a configuration in which the output voltage fluctuates depending on the situation.

The voltage measurer 11 measures the output voltage of the power supply 10. Herein, the output voltage of the power supply 10 is input to the linear regulator 12 and the switching regulator 13. In the example illustrated in FIG. 1, the voltage measurer 11 is installed at the stage prior to the linear regulator 12 and the switching regulator 13; while the voltage measurer 11 is installed at the stage prior to the power supply 10.

FIG. 2 is a diagram illustrating an exemplary configuration of the voltage measurer 11 according to the embodiment. In the example illustrated in FIG. 2, the voltage measurer 11 includes an analog/digital converter (hereinafter, called “ADC”) 20, which converts the analog value of the output voltage of the power supply 10 into digital data in response to a request from the controller 16 and notifies the controller 16 about the conversion result (the measurement result of measuring the output voltage of the power supply 10). For example, the controller 16 can request the ADC 20 to periodically measure the output voltage of the power supply 10.

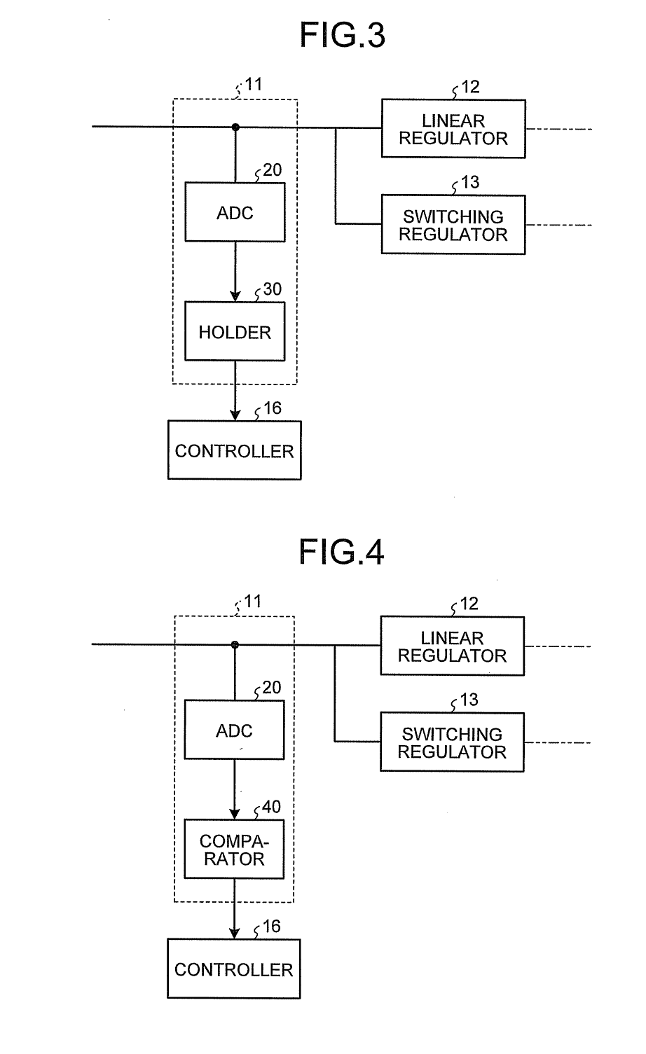

Meanwhile, for example, as illustrated in FIG. 3, the voltage measurer 11 can also include a holder 30 that holds the measurement result obtained by the ADC 20. In that case, for example, the configuration can be such that the ADC 20 periodically measures the output voltage of the power supply 10 and writes the measurement result in the holder 30. In this configuration, every time the ADC 20 performs measurement, the measurement result held by the holder 30 is updated. Then, as may be necessary, the controller 16 can read the value held by the holder 30.

Alternatively, for example, as illustrated in FIG. 4, the voltage measurer 11 can include the ADC 20 and a comparator 40. If the measurement result obtained by the ADC 20 exceeds a threshold value or falls below a threshold value, then the comparator 40 notifies the controller 16 about the measurement result obtained by the ADC 20. Thus, in the example illustrated in FIG. 4, when the output voltage of the power supply 10 fluctuates to a large extent, the controller 16 is notified about the measurement result of measuring the output voltage of the power supply 10.

Returning to the explanation with reference to FIG. 1, the linear regulator 12 supplies electrical power to the load 200, and steps down the output voltage of the power supply 10 to a predetermined voltage value. In the embodiment, the linear regulator 12 steps down the output voltage of the power supply 10 to a (predetermined) voltage value required by the load 200. The linear regulator 12 represents a regulator that causes voltage drop in the input voltage with the use of an element such as a resistor, and obtains the desired output voltage. Herein, the linear regulator 12 has an identical configuration to a known linear regulator (sometimes also called a “series regulator”).

The switching regulator 13 supplies electrical power to the load 200, and steps down the output voltage of the power supply 10 to a predetermined voltage value. In the embodiment, the switching regulator 13 steps down the output voltage of the power supply 10 to a (predetermined) voltage value required by the load 200. The switching regulator 13 represents a regulator that performs smoothing with respect to the square waves of the input voltage that is obtained by controlling the ratio (duty ratio) of the ON/OFF time of a switching element, and obtains the desired output voltage. Herein, the switching regulator 13 has an identical configuration to a known switching regulator.

Under the control of the controller 16, the switcher 14 switches between a state in which electrical power is supplied to the load 200 from the linear regulator 12 and a state in which electrical power is supplied to the load 200 from the switching regulator 13. In the embodiment, the switcher 14 is capable of switching between the following two states: a state in which the linear regulator 12 is connected to the load current measurer 15 that is in turn connected to the load 200 and in which the voltage stepped down by the linear regulator 12 is supplied to the load 200 (i.e., a state in which the switching regulator 13 is not connected to the load current measurer 15); and a state in which the switching regulator 13 is connected to the load current measurer 15 that is in turn connected to the load 200 and in which the voltage stepped down by the switching regulator 13 is supplied to the load 200 (i.e., a state in which the linear regulator 12 is not connected to the load current measurer 15). In the example illustrated in FIG. 1, the switcher 14 includes a first switch SW1 and a second switch SW2.

The first switch SW1 is disposed in between the linear regulator 12 and the load current measurer 15. The second switch SW2 is disposed in between the switching regulator 13 and the load current measurer 15. In the state in which the first switch SW1 is turned ON and the second switch SW2 is turned OFF, electrical power to the load 200 is supplied from the linear regulator 12. On the other hand, in the state in which the first switch SW1 is turned OFF and the second switch SW2 is switched turned ON, electrical power to the load 200 is supplied from the switching regulator 13.

The first switch SW1 as well as the second switch SW2 can be configured with, for example, a bipolar transistor, a field-effect transistor, a trench-MOS-assisted bipolar-mode FET, a phototransistor, an electrostatic induction transistor, a power bipolar transistor, a reverse conducting thyristor, a gate-assisted turn-off thyristor, a gate-assisted turn-on thyristor, a gate commutating turn-off thyristor, a light triggered thyristor, or a bidirectional thyristor.

The ON/OFF control of the first switch SW1 and the second switch SW2 is performed by the controller 16. In the embodiment, in the case of performing settings to supply electrical power to the load 200 from the linear regulator 12 (i.e., in the case of performing control to supply electrical power to the load 200 from the linear regulator 12), the controller 16 performs control to turn ON the first switch SW1 and turn OFF the second switch SW2. As a result, the linear regulator 12 is connected with the load current measurer 15 so that the voltage stepped down by the linear regulator 12 is supplied to the load 200. On the other hand, in the case of performing settings to supply electrical power to the load 200 from the switching regulator 13 (i.e., in the case of performing control to supply electrical power to the load 200 from the switching regulator 13), the controller 16 performs control to turn OFF the first switch SW1 and turn ON the second switch SW2. As a result, the switching regulator 13 is connected with the load current measurer 15 so that the voltage stepped down by the switching regulator 13 is supplied to the load 200. Although described later in detail, in the embodiment, the controller 16 controls the switcher 14 based on the output voltage of the power supply 10 as measured by the voltage measurer 11 and based on the load current measured by the load current measurer 15.

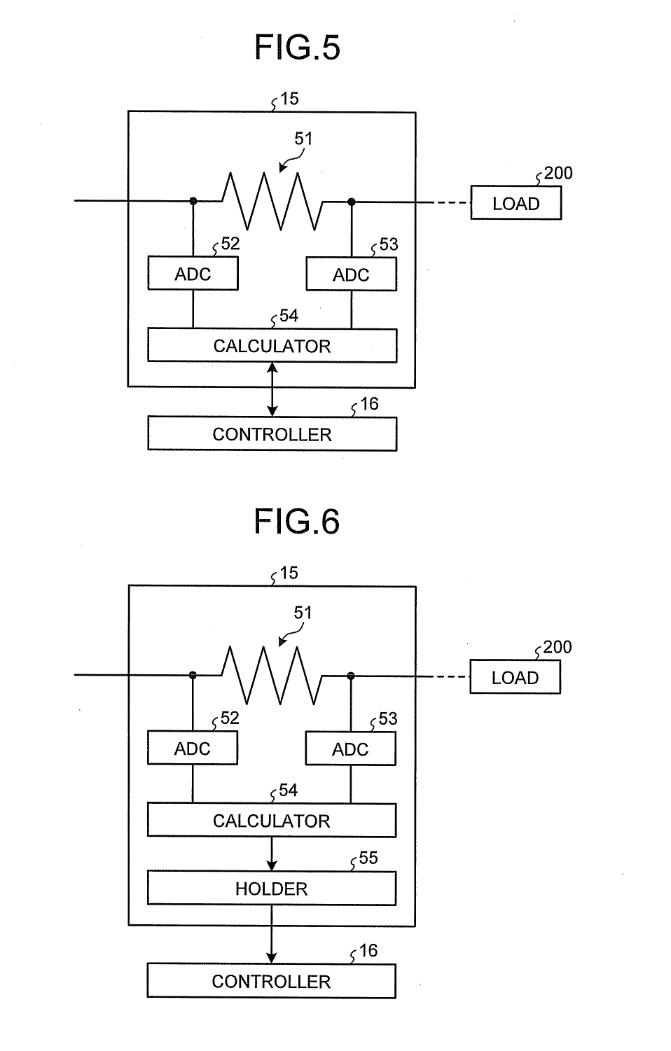

The load current measurer 15 measures the load current that represents the electrical current flowing to the load 200. In the example illustrated in FIG. 1, the load current measurer 15 is disposed in between the load 200 and the switcher 14. FIG. 5 is a diagram illustrating an exemplary configuration of the load current measurer 15 according to the embodiment. In the example illustrated in FIG. 5, the load current measurer 15 includes a shunt resistor 51, ADCs 52 and 53, and a calculator 54. The ADC 52 converts the analog value of one terminal of the shunt resistor 51 (the terminal closer to the switcher 14) into digital data. The ADC 53 converts the analog value of the other terminal of the shunt resistor 51 (the terminal closer to the load 200) into digital data. The calculator 54 measures the load current in response to a request from the controller 16 and notifies the controller 16 about the measurement result. For example, the controller 16 can be configured to periodically request the calculator 54 to measure the load current, or can be configured to request the measurement of the load current in case of any change (such as a change in the usage environment of the load 200). Alternatively, for example, only when the measurement result of measuring the load current exceeds a threshold value, the calculator 54 can be configured to notify the controller 16 about that measurement result.

Given below is the detailed explanation of the measurement method implemented by the load current measurer 15. The calculator 54 refers to the difference between the digital data obtained by conversion by the ADC 52 and the digital data obtained by conversion by the ADC 53, and accordingly obtains the voltage difference between the terminals of the shunt resistor 51. Then, the calculator 54 divides the voltage difference between the terminals of the shunt resistor 51 by a predetermined resistance value of the shunt resistor 51, and obtains the value of electrical current (load current) flowing to the shunt resistor 51.

Alternatively, for example, as illustrated in FIG. 6, the load current measurer 15 may also include a holder 55 that holds the calculation result obtained by the calculator 54 (i.e., the measurement result of measuring the load current). In that case, for example, the calculator 54 can be configured to periodically calculate the load current and write the calculation result in the holder 55. In such a configuration, every time the calculator 54 performs the calculation, the calculation result held by the holder 55 is updated. Then, as may be necessary, the controller 16 can read the value held by the holder 55.

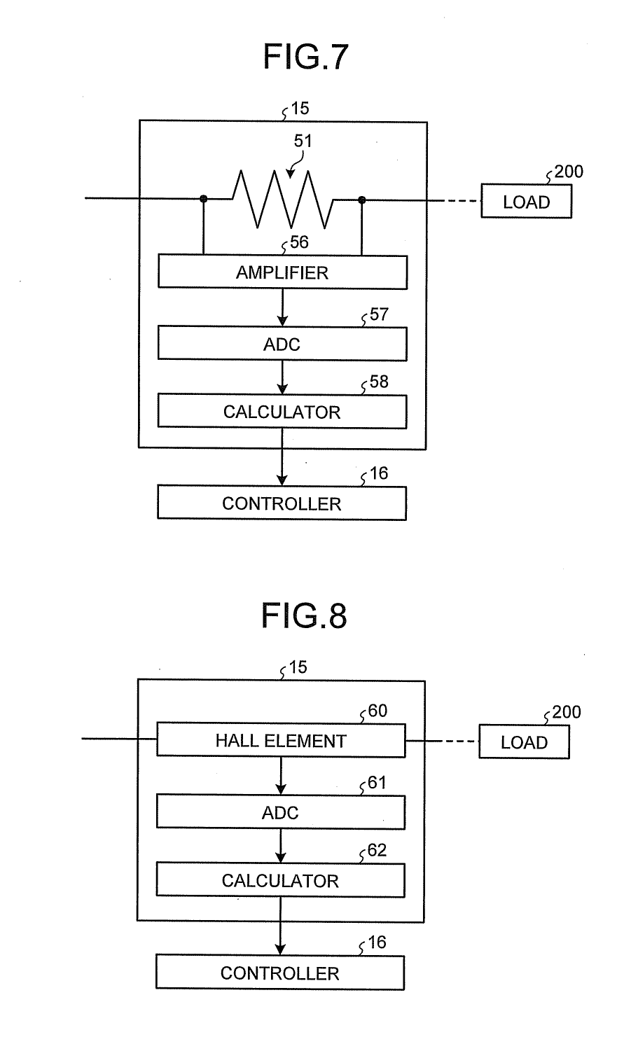

Still alternatively, for example, as illustrated in FIG. 7, the load current measurer 15 can be configured to include an amplifier 56 that amplifies the voltage at both terminals of the shunt resistor 51. Since the shunt resistor 51 has only a small resistance value, the voltage difference that inevitably occurs in the shunt resistor 51 (i.e., the voltage difference between both terminals of the shunt resistor 51) inevitably becomes small too. Since an ADC has a finite resolution capability, it is possible to think of a case in which the value of the voltage difference is rounded due to the quantization error and is considered to be equal to zero. In order to avoid that risk, the value of the voltage difference between both terminals of the shunt resistor 51 is amplified using the amplifier 56. In the example illustrated in FIG. 7, the load current measurer 15 also includes an ADC 57 and a calculator 58. The ADC 57 converts the analog value of the amplified voltage difference, which is amplified by the amplifier 56, into digital data. Then, in response to a request from the controller 16, the calculator 58 obtains the digital data obtained by conversion by the ADC 57, divides the obtained digital data by a predetermined resistance value of the shunt resistor 51 as well as by the gain of the amplifier 56, and obtains the value of electrical current (load current) flowing to the shunt resistor 51. Moreover, in an identical manner to the example illustrated in FIG. 6, a holder can also be disposed for the purpose of holding the calculation result obtained by the calculator 58.

Still alternatively, for example, as illustrated in FIG. 8, the load current measurer 15 can be configured to include a Hall element 60 in place of the shunt resistor 51. The Hall element 60 is based on the Hall effect, and outputs a voltage proportional to the electrical current value flowing thereto. Hence, from a characteristic table indicating the relationship between the electrical current values and the voltage values, it is possible to calculate the value of electrical current (load current) flowing to the Hall element 60. In the example illustrated in FIG. 8, the load current measurer 15 further includes an ADC 61 and a calculator 62. The ADC 61 converts the analog value of the voltage output of the Hall element 60 into digital data. Then, in response to a request from the controller 16, the calculator 62 obtains the digital data obtained by conversion by the ADC 61 and, from a characteristic table provided in advance (for example, a characteristic table stored in a memory), obtains the electrical current value corresponding to the voltage value indicated by the obtained digital data (i.e., obtains the value of electrical current flowing to the Hall element 60, that is, obtains the value of the load current).

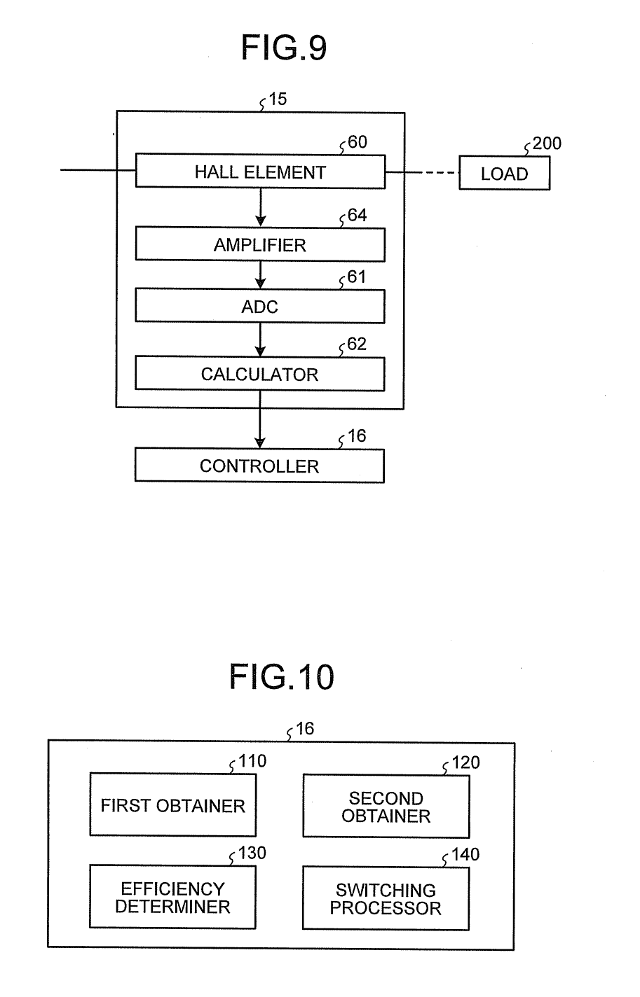

Meanwhile, the output voltage of the Hall element 60 is very small. Hence, as illustrated in FIG. 9, an amplifier 64, which amplifies the output voltage of the Hall element 60, can be disposed in between the Hall element 60 and the ADC 61.

Still alternatively, the configuration can be such that a comparator, which determines whether or not the calculation result of a calculator (the measurement result of measuring the load current) has exceeded a threshold value, is disposed in the load current measurer 15 illustrated in FIGS. 5 to 9. For example, when the measurement result of measuring the load current exceeds the threshold value or falls below the threshold value, the comparator can notify the controller 16 about the measurement result of measuring the load current.

Returning to the explanation with reference to FIG. 1, the controller 16 performs control to supply electrical power to the load 200 from one of the linear regulator 12 and the switching regulator 13 based on the output voltage of the power supply 10 (equated with an input voltage of the linear regulator 12 and the switching regulator 13 herein) and based on the load current. More particularly, the controller 16 performs control to supply electrical power to the load 200 from the regulator having higher efficiency from among the linear regulator 12 and the switching regulator 13. That is, the controller 16 calculates the efficiency of the linear regulator 12 and the efficiency of the switching regulator 13 by using the output voltage of the power supply 10 and the load current. Then, the controller 16 compares the two efficiencies, and performs control to supply electrical power to the load 200 from the regulator having higher efficiency.

The controller 16 divides the preset output voltage of the linear regulator 12 by the voltage value measured by the voltage measurer 11 (i.e., the output voltage of the power supply 10), to thereby obtain the efficiency of the linear regulator 12. Moreover, the controller 16 refers to correspondence information (for example, information in a table form) in which the efficiencies are associated to combinations of a plurality of types of output voltages of the power supply 10 and a plurality of types of load currents, and obtains the efficiency associated to the combination of the present output voltage of the power supply 10 and the present load current (i.e., the combination of the latest output voltage of the power supply 10 as measured by the voltage measurer 11 and the latest load current measured by the load current measurer 15) as the efficiency of the switching regulator 13. Given below is the explanation of the specific details of the controller 16.

FIG. 10 is a diagram illustrating an exemplary functional configuration of the controller 16. As illustrated in FIG. 10, the controller 16 includes a first obtainer 110, a second obtainer 120, an efficiency determiner 130, and a switching processor 140.

The first obtainer 110 obtains the output voltage of the power supply 10. More particularly, the first obtainer 110 obtains the voltage value measured by the voltage measurer 11 (i.e., the output voltage of the power supply 10). The second obtainer 120 obtains the load current. More particularly, the second obtainer 120 obtains the electrical current value (the load current) measured by the load current measurer 15.

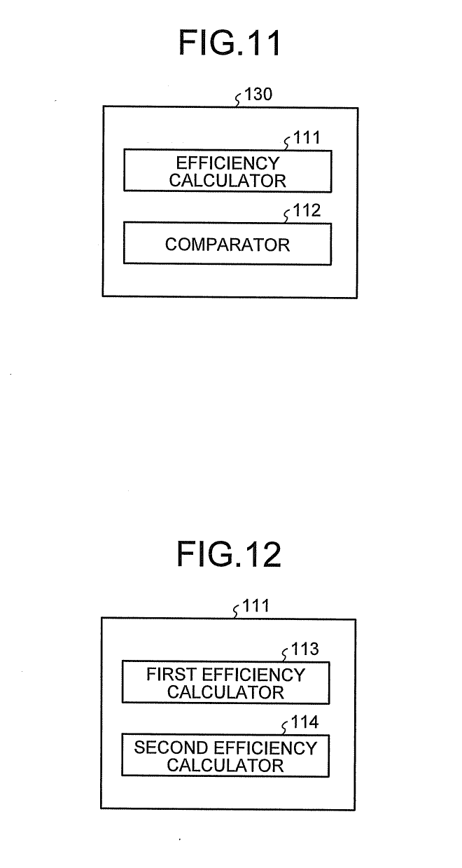

The efficiency determiner 130 calculates the efficiency of the linear regulator 12 and the efficiency of the switching regulator 13 by using the output voltage of the power supply 10 as obtained by the first obtainer 110 and the load current obtained by the second obtainer 120; compares the two efficiencies; and determines the regulator having higher efficiency. In the embodiment, as illustrated in FIG. 11, the efficiency determiner 130 includes an efficiency calculator 111 and a comparator 112.

The efficiency calculator 111 calculates the efficiency of the linear regulator 12 and the efficiency of the switching regulator 13. In the embodiment, as illustrated in FIG. 12, the efficiency calculator 111 includes a first efficiency calculator 113 and a second efficiency calculator 114. The first efficiency calculator 113 calculates the efficiency of the linear regulator 12. More particularly, the first efficiency calculator 113 divides a preset output voltage Vout of the linear regulator 12 by an output voltage Vin of the power supply 10 as obtained by the first obtainer 110, to thereby obtain an efficiency η1(=Vout/Vin) of the linear regulator 12.

The second efficiency calculator 114 calculates the efficiency of the switching regulator 13. More particularly, the second efficiency calculator 114 refers to correspondence information in which the efficiencies are associated to combinations of a plurality of types of output voltages of the power supply 10 and a plurality of types of load currents, and obtains the efficiency associated to the combination of the output voltage Vin of the power supply 10 as obtained by the first obtainer 110 and a load current Iload obtained by the second obtainer 120 as the efficiency of the switching regulator 13.

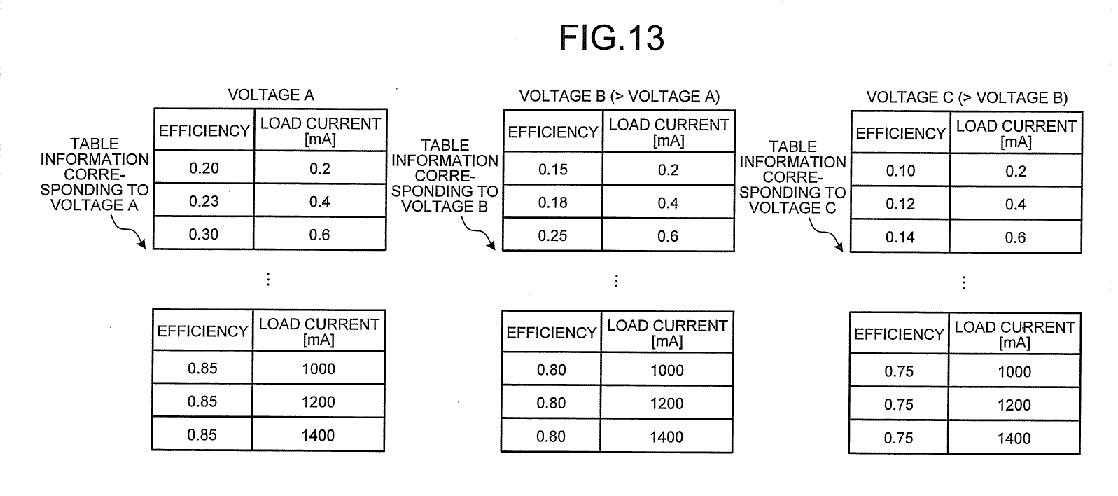

FIG. 13 is a diagram illustrating an example of correspondence information according to the embodiment. The correspondence information is held in the second efficiency calculator 114 or in an external memory (not illustrated). In the example illustrated in FIG. 13, in the correspondence information, table information that indicates the correspondence relationship between the load current and the efficiency is associated to each of a plurality of types of voltage outputs of the power supply 10 (in this example, although there are three types of voltages, namely, voltages A, B, and C; it is not the only possible case). However, that is not the only possible case. In the example illustrated in FIG. 13, the second efficiency calculator 114 reads, from the correspondence information, the efficiency associated to the combination of a voltage that, from among a plurality of types of voltages specified in the correspondence information, is close to the output voltage Vin of the power supply 10 as obtained by the first obtainer 110 and a load current that, from among a plurality of types of load currents specified in the correspondence information, is close to the load current Iload obtained by the second obtainer 120, to thereby obtain the read efficiency as the efficiency of the switching regulator 13.

More particularly, firstly, the second efficiency calculator 114 selects, from among the three pieces of table information associated on a one-to-one basis with the three types of voltages (A, B, and C), the piece of table information associated to the voltage that is close to the output voltage Vin of the power supply 10 as obtained by the first obtainer 110. For example, if the output voltage Vin of the power supply 10 as obtained by the first obtainer 110 is equal to or smaller than the average value of the voltages A and B (in the example illustrated in FIG. 13, the voltage B is greater than the voltage A), then the second efficiency calculator 114 considers that the output voltage Vin of the power supply 10 is closer to the voltage A and selects the table information associated to the voltage A. On the other hand, if the output voltage Vin of the power supply 10 is greater than the average value of the voltages A and B, then the second efficiency calculator 114 considers that the output voltage Vin of the power supply 10 is closer to the voltage B and selects the table information associated to the voltage B.

Then, in the selected table information, the second efficiency calculator 114 selects, from among a plurality of efficiencies associated on a one-to-one basis to a plurality of types of load currents, the efficiency associated to the load current that is close to the load current Iload obtained by the second obtainer 120. For example, assume that the load current Iload obtained by the second obtainer 120 is in between two load currents Ia and Ib specified in the selected table information. If the load current Iload is equal to or smaller than the average value of the load currents Ia and Ib, then the second efficiency calculator 114 obtains an efficiency ηa corresponding to the load current Ia as the efficiency of the switching regulator 13 at the output voltage Vin of the power supply 10 and the load current Iload. On the other hand, if the load current Iload is greater than the average value of the load currents Ia and Ib, then the second efficiency calculator 114 obtains an efficiency ηb corresponding to the load current Ib as the efficiency of the switching regulator 13 at the output voltage Vin of the power supply 10 and the load current Iload.

Returning to the explanation with reference to FIG. 11, the comparator 112 compares the two efficiencies calculated by the efficiency calculator 111, and determines the higher efficiency. Then, the comparator 112 notifies the switching processor 140 about the determination result (the comparison result).

The switching processor 140 controls the switcher 14 in such a way that electrical power to the load 200 is supplied from one of the linear regulator 12 and the switching regulator 13 that has been determined to have higher efficiency by the efficiency determiner 130. For example, if the efficiency determiner 130 determines that the linear regulator 12 has higher efficiency than the switching regulator 13, then the switching processor 140 controls the switcher 14 to supply electrical power to the load 200 from the linear regulator 12. In this example, the switching processor 140 performs control to turn ON the first switch SW1 and to turn OFF the second switch SW2. On the other hand, if the efficiency determiner 130 determines that the linear regulator 12 has lower efficiency than the switching regulator 13, then the switching processor 140 controls the switcher 14 to supply electrical power to the load 200 from the switching regulator 13. In this example, the switching processor 140 performs control to turn OFF the first switch SW1 and to turn ON the second switch SW2.

In the embodiment, the controller 16 is configured with a computer device including a central processing unit (CPU), a read only memory (ROM), and a random access memory (RAM). When the CPU loads computer programs, which are stored in the ROM, in the RAM and executes them; the functions of the first obtainer 110, the second obtainer 120, the efficiency determiner 130 (including the first efficiency calculator 113, the second efficiency calculator 114, and the comparator 112), and the switching processor 140 are implemented. However, that is not the only possible case. Alternatively, for example, at least some of the first obtainer 110, the second obtainer 120, the efficiency determiner 130 and the switching processor 140 can be implemented using dedicated hardware circuitry (such as a semiconductor integrated circuit). Meanwhile, in this example, the controller 16 can be considered to be corresponding to a “control device” mentioned in claims.

The controller 16 can be configured with, for example, a microcontroller (MCU), which has built-in functions of an analog/digital converter, an amplifier, and a general purpose input/output; and is thus capable of measuring the output voltage of the power supply 10 and measuring the load current. In essence, the controller 16 can be configured to have at least some functions of the voltage measurer 11 and the load current measurer 15. Given below is the explanation of the method of measuring the output voltage of the power supply 10 and the method of measuring the load current in the case in which the controller 16 is configured with an MCU.

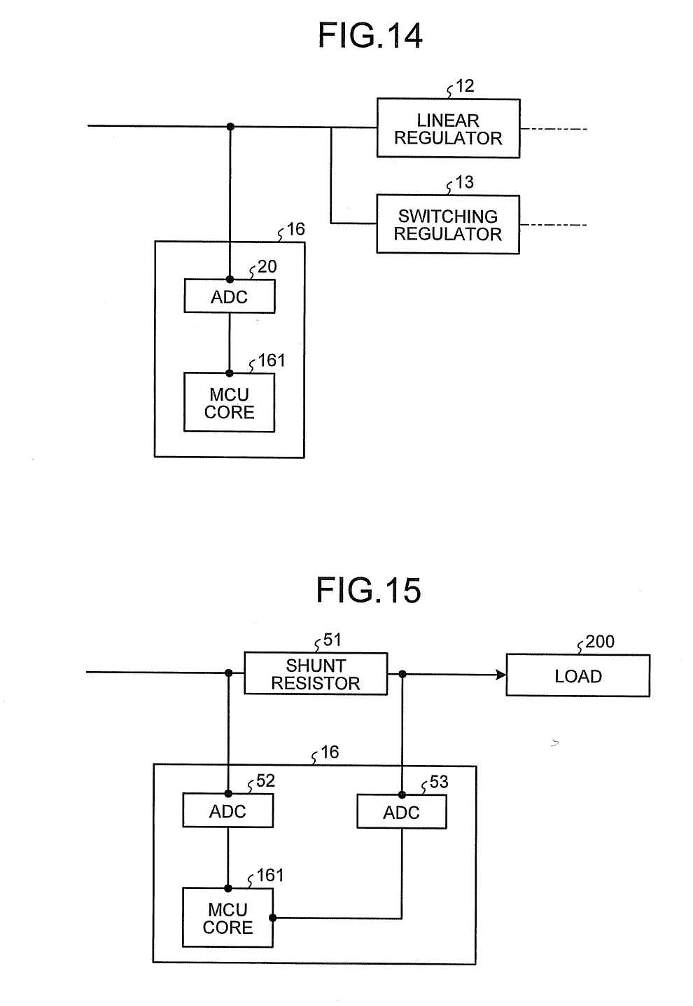

For example, as illustrated in FIG. 14, the ADC 20 illustrated in FIG. 2 can be embedded in the MCU so that the output voltage of the power supply 10 is measured using the ADC 20. In response to a request from a built-in MCU core 161 of the MCU, the ADC 20 converts the analog value of the output voltage of the power supply 10 into digital data and notifies the MCU core 161 about the conversion result (the measurement result of measuring the output voltage of the power supply 10).

For example, as illustrated in FIG. 15, the ADCs 52 and 53 illustrated in FIGS. 5 and 6 can be embedded in the MCU so that the voltage difference between both terminals of the shunt resistor 51 is measured using the ADCs 52 and 53. In that case, the MCU core 161 refers to the difference between the digital data obtained by conversion by the ADC 52 and the digital data obtained by conversion by the ADC 53, and accordingly obtains the voltage difference between the terminals of the shunt resistor 51. Then, the MCU core 161 divides the voltage difference, which is obtained between the terminals of the shunt resistor 51, by a predetermined resistance value of the shunt resistor 51, and accordingly obtains the value of electrical current (load current) flowing to the shunt resistor 51.

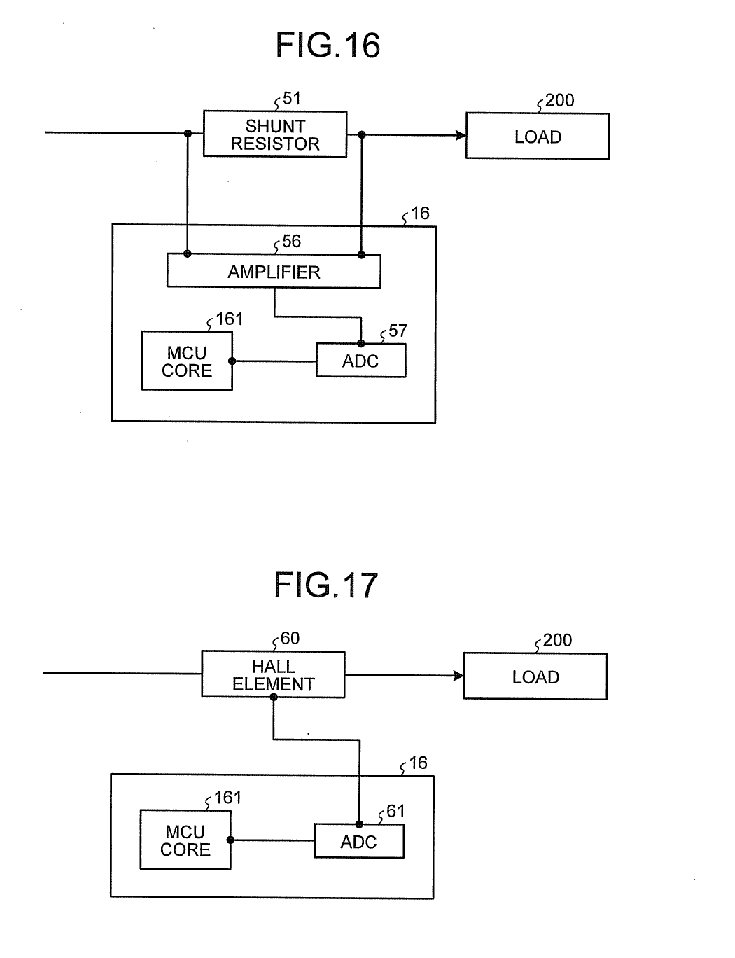

Alternatively, for example, as illustrated in FIG. 16, the amplifier 56 and the ADC 57 illustrated in FIG. 7 can be embedded in the MCU so that the amplifier 56 amplifies the voltage difference between both terminals of the shunt resistor 51, and the ADC 57 converts the amplification result into digital data and notifies the MCU core 161 about the digital data. In that case, the MCU core 161 divides the digital data, which is notified by the ADC 57, by a predetermined resistance value of the shunt resistor 51 as well as by the gain of the amplifier 56, and accordingly obtains the value of electrical current (load current) flowing to the shunt resistor 51.

Still alternatively, for example, as illustrated in FIG. 17, the Hall element 60 can be used in place of the shunt resistor 51; and the ADC 61 embedded in the MCU can convert the analog value of the output voltage of the Hall element 60 and notify the MCU core 161 about the conversion result. The Hall element 60 outputs a voltage proportional to the electrical current value flowing thereto. Hence, from a characteristic table indicating the relationship between the electrical current values and the voltage values, the MCU core 161 calculates the value of electrical current (load current) flowing to the Hall element 60.

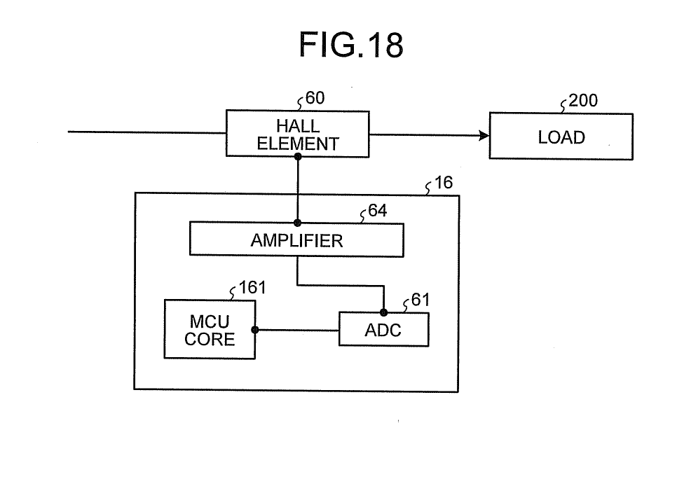

Still alternatively, for example, as illustrated in FIG. 18, the configuration can be such that the amplifier 64 embedded in the MCU amplifies the output voltage of the Hall element 60; and the ADC 61 embedded in the MCU converts the amplified voltage into digital data and notifies the MCU core 161 about the digital data. In that case, the MCU core 161 divides the digital data, which is notified by the ADC 61, by the gain of the amplifier 64 and, from a characteristic table indicating the relationship between the electrical current values and the voltage values, obtains the value of electrical current (load current) flowing to the Hall element 60.

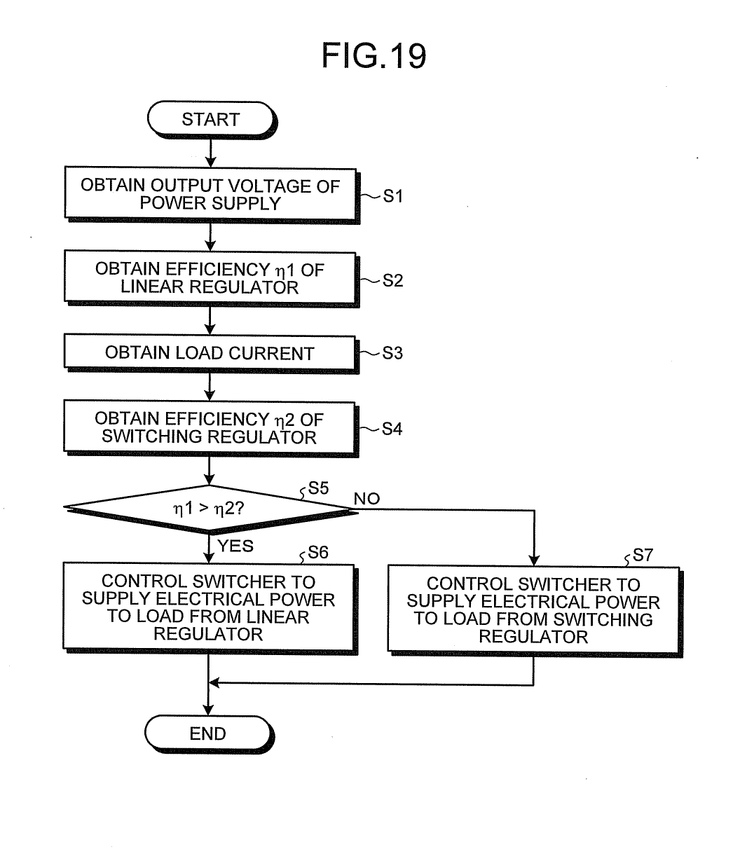

Given below is the explanation of an example of operations performed by the controller 16. FIG. 19 is a flowchart for explaining an example of operations performed by the controller 16. Herein, the initial state of the power system 100 can either be the state in which electrical power to the load 200 is supplied from the linear regulator 12 or be the state in which electrical power to the load 200 is supplied from the switching regulator 13.

As illustrated in FIG. 19, firstly, the first obtainer 110 obtains the output voltage of the power supply 10 as measured by the voltage measurer 11 (Step S1). Then, the first efficiency calculator 113 divides a preset output voltage of the linear regulator 12 by the output voltage of the power supply 10 as obtained at Step S1, to thereby obtain the efficiency η1 of the linear regulator 12 (Step S2).

Subsequently, the second obtainer 120 obtains the load current measured by the load current measurer 15 (Step S3). Then, the second efficiency calculator 114 calculates the efficiency η2 of the switching regulator 13 by using the output voltage of the power supply 10 as obtained at Step S1 and the load current obtained at Step S3 (Step S4). As described earlier, the second efficiency calculator 114 refers to the correspondence information, and accordingly obtains the efficiency associated to the combination of the output voltage of the power supply 10 as obtained at Step S1 and the load current obtained at Step S3 as the efficiency of the switching regulator 13.

Subsequently, the comparator 112 compares the efficiency 11 obtained at Step S2 with the efficiency η2 obtained at Step S4, and determines whether or not the efficiency η1 is greater than the efficiency η2 (Step S5). If the efficiency 11 is greater than the efficiency 12 (Yes at Step S5), the switching processor 140 controls the switcher 14 so that electrical power to the load 200 is supplied from the linear regulator 12 (Step S6). That is, the switching processor 140 performs control to turn ON the first switch SW1 and to turn OFF the second switch SW2. On the other hand, if the efficiency η1 is smaller than the efficiency η2 (No at Step S5), the switching processor 140 controls the switcher 14 so that electrical power to the load 200 is supplied from the switching regulator 13 (Step S7). That is, the switching processor 140 performs control to turn OFF the first switch SW1 and to turn ON the second switch SW2.

The controller 16 performs these operations in a repeated manner. Examples of the trigger for performing the operations include interrupts issued at regular intervals from a timer (not illustrated), detection of a change in the state of the load 200, and a case in which the measurement result obtained by the voltage measurer 11 by measuring the output voltage of the power supply 10 or the measurement result obtained by the load current measurer 15 by measuring the load current either exceeds or falls below a threshold value (one or more threshold values can be set).

In the embodiment described above, it is possible to think that, based on the output voltage of the power supply 10 and based on the load current, the controller 16 performs control to supply electrical power to the load 200 from one of the linear regulator 12 and the switching regulator 13. A computer program written to make the controller 16 (a computer) perform the abovementioned operation can be saved as a downloadable file on a computer connected to a network such as the Internet or can be made available for distribution through a network such as the Internet. Alternatively, the computer program can be stored in advance in a nonvolatile recording medium such as a ROM.

As described above, based on the output voltage of the power supply 10 and based on the load current, the controller 16 according to the embodiment performs control to supply electrical power to the load 200 from one of the linear regulator 12 and the switching regulator 13. More particularly, the controller 16 performs control to supply electrical power to the load 200 from the regulator having higher efficiency from among the linear regulator 12 and the switching regulator 13. That is, the controller 16 calculates the efficiency of the linear regulator 12 and the efficiency of the switching regulator 13 by using the output voltage of the power supply 10 and the load current. Then, the controller 16 compares the two efficiencies, and performs control to supply electrical power to the load 200 from the regulator having higher efficiency. Hence, for example, even in the case when a photovoltaic cell, in which the output voltage fluctuates depending on the situation, is used as the power supply 10 (i.e., even if the output voltage of the power supply 10 undergoes fluctuation); control can be performed to supply electrical power to the load 200 from the regulator having higher efficiency from among the linear regulator 12 and the switching regulator 13. Therefore, electrical power saving can be achieved in an appropriate manner.

It is possible to set in advance the condition for selecting the supply of electrical power to the load 200 from the linear regulator 12 (i.e., the condition regarding the output voltage of the power supply 10 and the load current in the case when the efficiency of the linear regulator 12 is higher than the efficiency of the switching regulator 13). Generally, when the load current is small, the switching regulator 13 has lower efficiency (see FIG. 13). However, the efficiency of the linear regulator 12 and the efficiency of the switching regulator 13 also depend on the value of the output voltage of the power supply 10. Therefore, even if the load current is small, depending on the value of the output voltage of the power supply 10, there are times when the efficiency of the switching regulator 13 is higher than the efficiency of the linear regulator 12. In that regard, it is possible to set in advance the condition regarding the output voltage of the power supply 10 and the load current in the case when the efficiency of the linear regulator 12 is higher than the efficiency of the switching regulator 13.

Examples of the conditions for selecting the supply of electrical power to the load 200 from the linear regulator 12 include: a first condition in which the value of the output voltage of the power supply 10 as measured by the voltage measurer 11 is equal to a first voltage value (corresponding to a first voltage mentioned in claims) and the value of the load current measured by the load current measurer 15 is equal to or smaller than a first electrical current value (corresponding to a first load current mentioned in claims); and a second condition in which the value of the output voltage of the power supply 10 as measured by the voltage measurer 11 is equal to a second voltage value (corresponding to a second voltage mentioned in claims) that is smaller than the first voltage value and the value of the load current measured by the load current measurer 15 is equal to or smaller than a second electrical current value (corresponding to a second load current mentioned in claims) that is smaller than the first electrical current value.

In this example, when the value of the output voltage of the power supply 10 as measured by the voltage measurer 11 is equal to the first voltage value and the value of the load current measured by the load current measurer 15 is equal to or smaller than the first electrical current value (i.e., when the first condition is satisfied), the controller 16 performs control to supply electrical power to the load 200 from the linear regulator 12 from among the linear regulator 12 and the switching regulator 13. Similarly, when the value of the output voltage of the power supply 10 as measured by the voltage measurer 11 is equal to the second voltage value and the value of the load current measured by the load current measurer 15 is equal to or smaller than the second electrical current value (i.e., when the second condition is satisfied), the controller 16 performs control to supply electrical power to the load 200 from the linear regulator 12 from among the linear regulator 12 and the switching regulator 13.

Meanwhile, alternatively, it is also possible to set in advance the condition for selecting the supply of electrical power to the load 200 from the switching regulator 13 (i.e., the condition regarding the output voltage of the power supply 10 and the load current in the case when the efficiency of the switching regulator 13 is higher than the efficiency of the linear regulator 12).

Examples of the conditions for selecting the supply of electrical power to the load 200 from the switching regulator 13 include: a third condition in which the value of the output voltage of the power supply 10 as measured by the voltage measurer 11 is equal to the first voltage value and the value of the load current measured by the load current measurer 15 is greater than the first electrical current value; and a fourth condition in which the value of the output voltage of the power supply 10 as measured by the voltage measurer 11 is equal to the second voltage value and the value of the load current measured by the load current measurer 15 is greater than the second electrical current value.

In this example, when the value of the output voltage of the power supply 10 as measured by the voltage measurer 11 is equal to the first voltage value and the value of the load current measured by the load current measurer 15 is greater than the first electrical current value (i.e., when the third condition is satisfied), the controller 16 performs control to supply electrical power to the load 200 from the switching regulator 13 from among the linear regulator 12 and the switching regulator 13. Similarly, when the value of the output voltage of the power supply 10 as measured by the voltage measurer 11 is equal to the second voltage value and the value of the load current measured by the load current measurer 15 is greater than the second electrical current value (i.e., when the fourth condition is satisfied), the controller 16 performs control to supply electrical power to the load 200 from the switching regulator 13 from among the linear regulator 12 and the switching regulator 13.

In essence, in a power system in which the invention is applied, it serves the purpose as long as the configuration is such that: when the output voltage of the power supply 10 is equal to the first voltage, the efficiency in the case when the load current is greater than the first load current is higher than the efficiency in the case when the load current is equal to the first load current; and when the output voltage of the power supply 10 is equal to the second voltage that is smaller than the first voltage, the efficiency in the case when the load current is greater than the second load current which is smaller than the first load current is higher than the efficiency in the case when the load current is equal to the second load current.

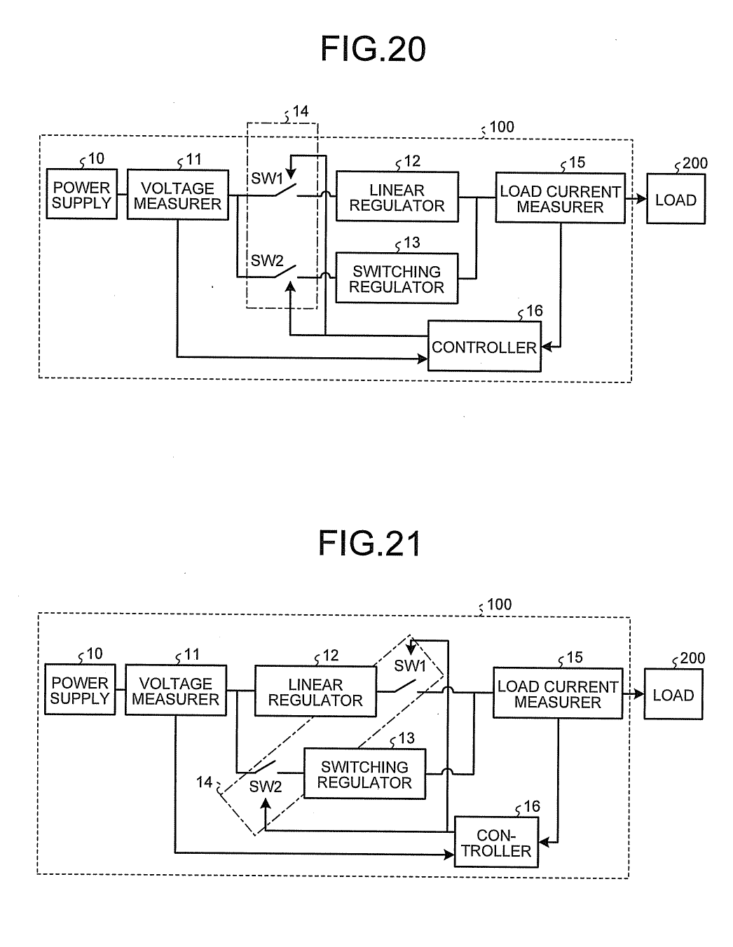

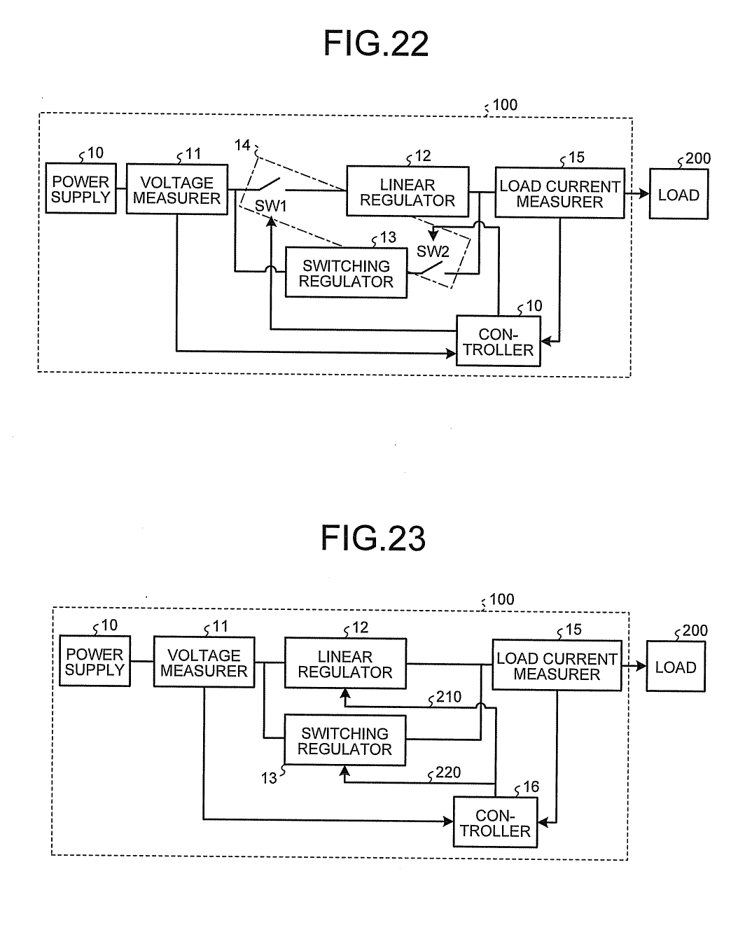

Meanwhile, the configuration of the switcher 14 is not limited to the configuration illustrated in FIG. 1, and can be changed in an arbitrary manner. For example, as illustrated in FIG. 20, the first switch SW1 can be disposed in between the voltage measurer 11 and the linear regulator 12, and the second switch SW2 can be disposed in between the voltage measurer 11 and the switching regulator 13. Alternatively, for example, as illustrated in FIG. 21, the first switch SW1 can be disposed in between the linear regulator 12 and the load current measurer 15, and the second switch SW2 can be disposed in between the voltage measurer 11 and the switching regulator 13. Still alternatively, for example, as illustrated in FIG. 22, the first switch SW1 can be disposed in between the voltage measurer 11 and the linear regulator 12, and the second switch SW2 can be disposed in between the switching regulator 13 and the load current measurer 15.

Still alternatively, for example, as illustrated in FIG. 23, the linear regulator 12 can be connected with an enable-signal line 210 to which enable signals are sent for the purpose of controlling the start and the end of the operations of the linear regulator 12. Similarly, the switching regulator 13 can be connected with an enable-signal line 220 to which enable signals are sent for the purpose of controlling the start and the end of the operations of the switching regulator 13. In such a configuration, the controller 16 can control the enable signals to be sent to the enable-signal lines 210 and 220, and thus can switch between a state in which electrical power to the load 200 is supplied from the linear regulator 12 from among the linear regulator 12 and the switching regulator 13 and a state in which electrical power to the load 200 is supplied from the switching regulator 13 from among the linear regulator 12 and the switching regulator 13.

Given below is the explanation of an exemplary situation in which the embodiment according to the invention is used. However, that is not the only possible case.

In recent years, there has been a demand to save electrical power in electrical devices. To save electrical power, it is possible to think of reducing the power consumption of the devices (load) and enhancing the efficiency of the power supply. For example, to a device driven by direct-current electricity, a switching regulator or a linear regulator is used for supplying electrical power from the power supply.

Typically, power systems are known in which the features of a switching regulator and a linear regulator are utilized. For example, as a conventional technology, a power system is known in which, depending on the electrical current (the load current) flowing to a device, control is performed to supply electrical power to the device from one of a linear regulator and a switching regulator. In that conventional technology, the power supplying source (the power supply) is a primary battery or a secondary battery having an almost constant output voltage. When the load current is equal to or smaller than a threshold value, control is performed to supply electrical power to the load from the linear regulator. On the other hand, when the load current is greater than the threshold value, control is performed to supply electrical power to the load from the switching regulator. As a result, depending on the fluctuation in the load current, electrical power can be supplied to the load in an efficient manner.

However, in the conventional technology, the power supply is assumed to be a primary battery or a secondary battery having an almost constant output voltage. However, if that power supply is replaced with a power supply such as a photovoltaic cell that has fluctuation in the output voltage depending on the situation; then, depending on the output voltage of the power supply, there are times when, even if the load current is small (during light load), the efficiency of the switching regulator is higher than the efficiency of the linear regulator. For that reason, in a configuration in which one of the switching regulator and the linear regulator is selected using only the magnitude of the load current, there are times when the efficiency undergoes a decline, and appropriate reduction in electrical power may not be achieved. In such a case, it is effective to implement the embodiment according to the invention.

Listed below are the features of an information processing method implemented by the controller 16 (a processor) according to the embodiment described above. A computer program written to make the controller 16 (a computer) implement the information processing method described below can be saved as a downloadable file on a computer connected to a network such as the Internet or can be made available for distribution through a network such as the Internet. Alternatively, the computer program can be stored in advance in a nonvolatile recording medium such as a ROM.

Aspect 1

An information processing method comprising a control step of performing, based on the output voltage of a power supply and based on a load current representing the electrical current flowing to a load, control to supply electrical power to the load from one of a linear regulator that supplies electrical power to the load and a step-down switching regulator that supplies electrical power to the load.

Aspect 2

The information processing method according to Aspect 1, wherein the control step includes performing control to supply electrical power to the load from a regulator having higher efficiency from among the linear regulator and the switching regulator.

Aspect 3

The information processing method according to Aspect 2, wherein the control step includes

calculating the efficiency of the linear regulator and the efficiency of the switching regulator by using the output voltage of the power supply and the load current,

comparing the two obtained efficiencies, and

performing control to supply electrical power to the load from the regulator having higher efficiency from among the linear regulator and the switching regulator.

Aspect 4

The information processing method according to Aspect 3, wherein the control step includes calculating the efficiency of the linear regulator by dividing a preset output voltage of the linear regulator by the output voltage of the power supply.

Aspect 5

The information processing method according to Aspect 3, wherein the control step includes

referring to correspondence information in which efficiencies are associated to combinations of a plurality of types of output voltages of the power supply and a plurality of types of load currents, and

calculating, as the efficiency of the switching regulator, the efficiency associated to a combination of the present output voltage of the power supply and the present load current.

Aspect 6

The information processing method according to Aspect 1, wherein the control step includes, based on the output voltage of the power supply and based on the load current, controlling a switcher that switches between a state in which electrical power is supplied to the load from the linear regulator and a state in which electrical power is supplied to the load from the switching regulator.

Aspect 7

The information processing method according to Aspect 6, wherein the control step includes

obtaining the output voltage of the power supply; the load current is obtained,

obtaining the efficiency of the linear regulator and the efficiency of the switching regulator by using the output voltage of the power supply and the load current,

comparing the two obtained efficiencies,

determining the regulator having higher efficiency from among the linear regulator and the switching regulator, and

controlling the switcher to supply electrical power to the load from either the linear regulator or the switching regulator determined to have higher efficiency in the determining.

Aspect 8

The information processing method according to Aspect 7, wherein the control step includes

obtaining the efficiency of the linear regulator and the efficiency of the switching regulator,

comparing the two obtained efficiencies, and

determining the higher efficiency of the two efficiencies.

Aspect 9

The information processing method according to Aspect 8, wherein

the control step includes
a first calculating step of calculating the efficiency of the linear regulator, and
a second calculating step of calculating the efficiency of the switching regulator,

the first calculating step includes calculating the efficiency of the linear regulator by dividing a preset output voltage of the linear regulator by the output voltage of the power supply that has been obtained, and

the second calculating step includes
referring to correspondence information in which efficiencies are associated to combinations of a plurality of types of output voltages of the power supply and a plurality of types of load currents, and
obtaining the efficiency associated to the combination of the obtained output voltage of the power supply and the obtained load current as the efficiency of the switching regulator.

Aspect 10

An information processing method comprising:
performing, when the output voltage of a power supply is equal to a first voltage and a load current representing the electrical current flowing to the load is equal to or smaller than a first load current, control to supply electrical power to the load from a linear regulator that supplies electrical power to a load from among the linear regulator and a step-down switching regulator that supplies electrical power to the load;

performing, when the output voltage of the power supply is equal to the first voltage and the load current is greater than the first load current, control to supply electrical power to the load from the switching regulator from among the linear regulator and the switching regulator;

performing, when the output voltage of the power supply is equal to a second voltage that is smaller than the first voltage and the load current is equal to or smaller than a second load current that is smaller than the first load current, control to supply electrical power to the load from the linear regulator from among the linear regulator and the switching regulator; and

performing, when the output voltage of the power supply is equal to the second voltage and the load current is greater than the second load current, control to supply electrical power to the load from the switching regulator from among the linear regulator and the switching regulator.

Aspect 11

An information processing method comprising:

performing, when the output voltage of a power supply is equal to a first voltage and a load current representing the electrical current flowing to the load is greater than a first load current, control to supply electrical power to the load from a step-down switching regulator that supplies electrical power to the load, from among a linear regulator that supplies electrical power to a load and the switching regulator; and

performing, when the output voltage of the power supply is equal to a second voltage that is smaller than the first voltage and the load current is greater than a second load current that is smaller than the first load current, control to supply electrical power to the load from the switching regulator from among the linear regulator and the switching regulator.

Aspect 12

An information processing method comprising:

performing, when the output voltage of a power supply is equal to a first voltage and a load current representing the electrical current flowing to the load is equal to or smaller than a first load current, control to supply electrical power to the load from a linear regulator that supplies electrical power to a load, from among the linear regulator and a step-down switching regulator that supplies electrical power to the load; and

performing, when the output voltage of the power supply is equal to a second voltage that is smaller than the first voltage and the load current is equal to or smaller than a second load current that is smaller than the first load current, control to supply electrical power to the load from the linear regulator from among the linear regulator and the switching regulator.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power system comprising:
a linear regulator to supply electrical power to a load;
a step-down switching regulator to supply electrical power to the load; and
a controller to, based on input voltage of the linear regulator and the step-down switching regulator and based on load current representing electrical current flowing to the load, perform control to supply electrical power to the load from one of the linear regulator and the switching regulator.

2. The system according to claim 1, wherein the controller performs control to supply electrical power to the load from a regulator having higher efficiency from among the linear regulator and the switching regulator.

3. The system according to claim 2, wherein the controller
calculates efficiency of the linear regulator and efficiency of the switching regulator by using the input voltage and the load current,
compares two calculated efficiencies, and
performs control to supply electrical power to the load from a regulator having higher efficiency from among the linear regulator and the switching regulator.

4. The system according to claim 3, wherein the controller calculates the efficiency of the linear regulator by dividing a preset output voltage of the linear regulator by the input voltage.

5. The system according to claim 3, wherein the controller
refers to correspondence information in which efficiencies are associated to combinations of a plurality of types of the input voltage and a plurality of types of the load current, and
calculates, as efficiency of the switching regulator, efficiency associated to a combination of a present input voltage of the linear regulator and the step-down switching regulator and a present load current.

6. The system according to claim 1, further comprising a switcher to switch between a state in which electrical power is supplied to the load from the linear regulator or a state in which electrical power is supplied to the load from the switching regulator, wherein
the controller controls the switcher based on the input voltage and based on the load current.

7. The system according to claim 6, wherein the controller includes
a first obtainer to obtain the input voltage,
a second obtainer to obtain the load current,
an efficiency determiner to
calculate efficiency of the linear regulator and efficiency of the switching regulator by using the input voltage and the load current,
compare two calculated efficiencies, and
determine a regulator having higher efficiency from among the linear regulator and the switching regulator, and
a switching processor to control the switcher to supply electrical power to the load from one of the linear regulator and the switching regulator, which has been determined to have the higher efficiency by the efficiency determiner.

8. The system according to claim 7, wherein the efficiency determiner includes
an efficiency calculator to calculate efficiency of the linear regulator and efficiency of the switching regulator, and
a comparator to compare two efficiencies calculated by the efficiency calculator and determine higher of the two efficiencies.

9. The system according to claim 8, wherein
the efficiency calculator includes
a first efficiency calculator to calculate efficiency of the linear regulator, and
a second efficiency calculator to calculate efficiency of the switching regulator,
the first efficiency calculator calculates the efficiency of the linear regulator by dividing a preset output voltage of the linear regulator by the input voltage as obtained by the first obtainer, and
the second efficiency calculator
refers to correspondence information in which efficiencies are associated to combinations of a plurality of types of the input voltage and a plurality of types of the load current, and
calculates, as efficiency of the switching regulator; efficiency associated to a combination of the input voltage as obtained by the first obtainer and the load current obtained by the second obtainer.

10. A power system comprising:
a linear regulator to supply electrical power to a load;
a step-down switching regulator to supply electrical power to the load; and
a controller to
when input voltage of the linear regulator and the step-down switching regulator is equal to a first voltage and load current representing electrical current flowing to the load is equal to or smaller than a first load current, perform control to supply electrical power to the load from the linear regulator from among the linear regulator and the switching regulator,
when the input voltage is equal to the first voltage and the load current is greater than the first load current, perform control to supply electrical power to the load from the switching regulator from among the linear regulator and the switching regulator,
when the input voltage is equal to a second voltage that is smaller than the first voltage and the load current is equal to or smaller than a second load current that is smaller than the first load current, perform control to supply electrical power to the load from the linear regulator from among the linear regulator and the switching regulator, and
when the input voltage is equal to the second voltage and the load current is greater than the second load current, perform control to supply electrical power to the load from the switching regulator from among the linear regulator and the switching regulator.

11. A power system comprising:
a linear regulator to supply electrical power to a load;
a step-down switching regulator to supply electrical power to the load; and
a controller to
when input voltage of the linear regulator and the step-down switching regulator is equal to a first voltage and load current representing electrical current flowing to the load is greater than a first load current, perform control to supply electrical power to the load from the switching regulator from among the linear regulator and the switching regulator, and
when the input voltage is equal to a second voltage that is smaller than the first voltage and the load current is greater than a second load current that is smaller than the first load current, perform control to supply electrical power to the load from the switching regulator from among the linear regulator and the switching regulator.

12. A power system comprising:
a linear regulator to supply electrical power to a load;
a step-down switching regulator to supply electrical power to the load; and
a controller to
when input voltage of the linear regulator and the step-down switching regulator is equal to a first voltage and load current representing electrical current flowing to the load is equal to or smaller than a first load current, perform control to supply electrical power to the load from the linear regulator from among the linear regulator and the switching regulator, and
when the input voltage is equal to a second voltage that is smaller than the first voltage and the load current is equal to or smaller than a second load current that is smaller than the first load current, perform control to supply electrical power to the load from the linear regulator from among the linear regulator and the switching regulator.

13. A power system that supplies electrical power to a load, wherein
when output voltage of a power supply is equal to a first voltage, efficiency in a case when load current representing electrical current flowing to the load is greater than a first load current is higher than efficiency in a case when the load current is equal to the first load current, and
when the output voltage of the power supply is equal to a second voltage that is smaller than the first voltage, efficiency in a case when the load current is greater than a second load current which is smaller than the first load current is higher than efficiency in a case when the load current is equal to the second load current.

14. A control device that controls a power system which supplies electrical power to a load, wherein
based on input voltage of a linear regulator and a step-down switching regulator and based on load current representing electrical current flowing to the load, the control device performs control to supply electrical power to the load from one of the linear regulator that supplies electrical power to the load and the step-down switching regulator that supplies electrical power to the load.

15. A control device that controls a power system which supplies electrical power to a load, wherein
when input voltage of a linear regulator and a step-down switching regulator is equal to a first voltage and load current representing electrical current flowing to the load is equal to or smaller than a first load current, the control device performs control to supply electrical power to the load from the linear regulator that supplies electrical power to the load, and performs control to not supply electrical power to the load from the step-down switching regulator that supplies electrical power to the load,
when the input voltage is equal to the first voltage and the load current is greater than the first load current, the control device performs control to supply electrical power to the load from the switching regulator and performs control to not supply electrical power to the load from the linear regulator,
when the input voltage is equal to a second voltage that is smaller than the first voltage and the load current is equal to or smaller than a second load current that is smaller than the first load current, the control device performs control to supply electrical power to the load from the linear regulator and performs control to not supply electrical power to the load from the switching regulator, and
when the input voltage is equal to the second voltage and the load current is greater than the second load current, the control device performs control to supply electrical power to the load from the switching regulator and performs control to not supply electrical power to the load from the linear regulator.
